(19) United States
(12) Patent Application Publication
(10) Pub. No.: US 2005/0127575 A1
(43) Pub. Date: Jun. 16, 2005

(54) Method of forming a vehicle trim panel

(76) Inventors: Alan G. Dry, Grosse Pointe Woods, MI (US); Michael P. Schoemann, Waterford, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/736,081

(22) Filed: Dec. 15, 2003

(51) Int. Cl. B29C 43/20

(52) U.S. Cl. 264/482; 264/248; 264/492

(57) ABSTRACT

A method of manufacturing a vehicle trim component includes providing a thermoplastic substrate. A first material, which is different from the material of the thermoplastic substrate, is also provided. A portion of a surface of the thermoplastic substrate is exposed to a source of heat such that the portion of the surface of the thermoplastic substrate exposed to the source of heat is melted. The first material is then positioned onto the thermoplastic substrate so as to bring the first material into contact with the melted surface of the thermoplastic substrate, thereby bonding the first material to the thermoplastic substrate and forming a vehicle trim component.

### BACKGROUND OF THE INVENTION

This invention relates to interior vehicle trim panels. More particularly, the invention relates to a method of manufacturing interior vehicle trim panels.

It is known to provide an interior trim panel for a vehicle which is aesthetically and/or tactilely pleasing to the vehicle occupants. Such interior trim panels typically comprise a relatively rigid structural substrate of thermoplastic or the like. The B-side surface of a cover-stock material such as leather, vinyl, or textile material is typically bonded to the A-side surface of the substrate. As used herein, the A-side surface refers to the surface of the substrate or the cover-stock which is exposed to the vehicle occupant. The B-side surface refers to the surface of the substrate or the cover-stock which is opposite the A-side surface and which faces away form the vehicle occupant. Commonly, cover-stock material is attached to the structural substrate by a variety of known methods, such as for example, by hand, by vacuum forming, and by low pressure molding.

However, known methods of manufacturing interior vehicle trim panels can add significant cost to each vehicle produced. It would therefore be desirable to provide an improved method of manufacturing an interior trim panel for a vehicle.

### SUMMARY OF THE INVENTION

The present invention relates to a method of manufacturing a vehicle trim component including providing a thermoplastic substrate. A first material, which is different from the material of the thermoplastic substrate, is also provided. A portion of a surface of the thermoplastic substrate is exposed to a source of heat such that the portion of the surface of the thermoplastic substrate exposed to the source of heat is melted. The first material is then positioned onto the thermoplastic substrate so as to bring the first material into contact with the melted surface of the thermoplastic substrate, thereby bonding the first material to the thermoplastic substrate and forming a vehicle trim component.

Other advantages of this invention will become apparent to those skilled in the art from the following detailed description of the invention, when read in light of the accompanying drawings.

### BRIEF DESCRIPTION OF THE DRAWINGS

FIG. 1 is an exploded perspective view of a vehicle trim panel manufactured according to the method of this invention.

FIG. 2 is a schematic perspective view of a press used in accordance with the method of this invention, showing the press in the open position.

FIG. 3 is a cross sectional elevational view showing the press illustrated in FIG. 1 in the closed position, showing vehicle trim panel therein.

FIG. 4 is a schematic perspective view of a press used in accordance with a second embodiment of the method of this invention, showing the press in the open position.

FIG. 5 is a schematic perspective view of a press used in accordance with a third embodiment of the method of this invention, showing the press in the open position.

FIG. 6 is a schematic perspective view of a press used in accordance with a fourth embodiment of the method of this invention, showing the press in the open position.

FIG. 7 is a cross sectional elevational view showing the press illustrated in FIG. 6 in the closed position, showing vehicle trim panel therein.

### DETAILED DESCRIPTION OF THE INVENTION

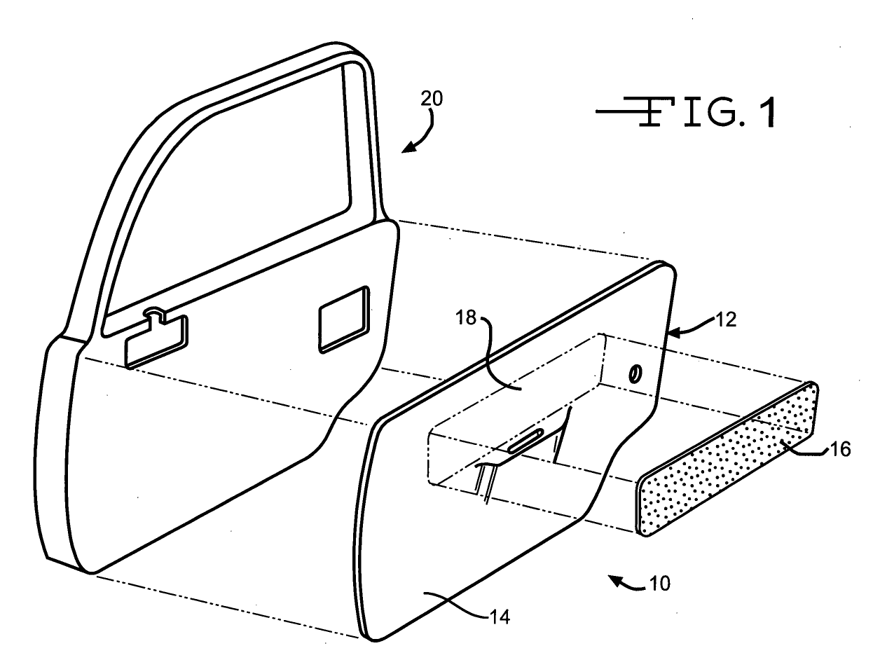

Referring now to the drawings, there is illustrated in FIG. 1 a vehicle trim component or panel assembly, generally shown at 10. The trim panel assembly 10 comprises a substrate or trim panel 12 having an A-side surface 14. The trim panel 12 includes a first material or coverstock 16 attached thereto. The coverstock 16 defines an accent region 18 (illustrated by a phantom line) of the trim panel 12.

The exemplary trim panel assembly 10 illustrated in FIG. 1 is an automotive door trim panel which mounts to a vehicle door assembly, generally shown at 20. It will be appreciated however, that the trim panel 12 of the subject invention may be any type of trim panel associated with a trim panel assembly for a vehicle. For example, other types of trim panels include trunk panels, quarter panels, rear package trays, headliners, instrument panels, garnish moldings, and console panels, among others.

The door trim panel 12 is preferably formed of a molded thermoplastic material such as polypropylene. As appreciated by those skilled in the art, the trim panel 12 may be fabricated of other materials, such as, polyurethane, solid molded vinyl, expanded polyurethane foam, any combination thereof, or any other desired thermoplastic material. The A-side surface 14 of the trim panel 12 may include a decorative surface portion, such as the accent region 18. The coverstock 16 is formed of any desired material, such as for example, vinyl, cloth, carpet, leather, or any other desired material. The trim panel 12 may be attached to the vehicle door assembly 20 by any suitable fasteners (not shown) as are well known in the art.

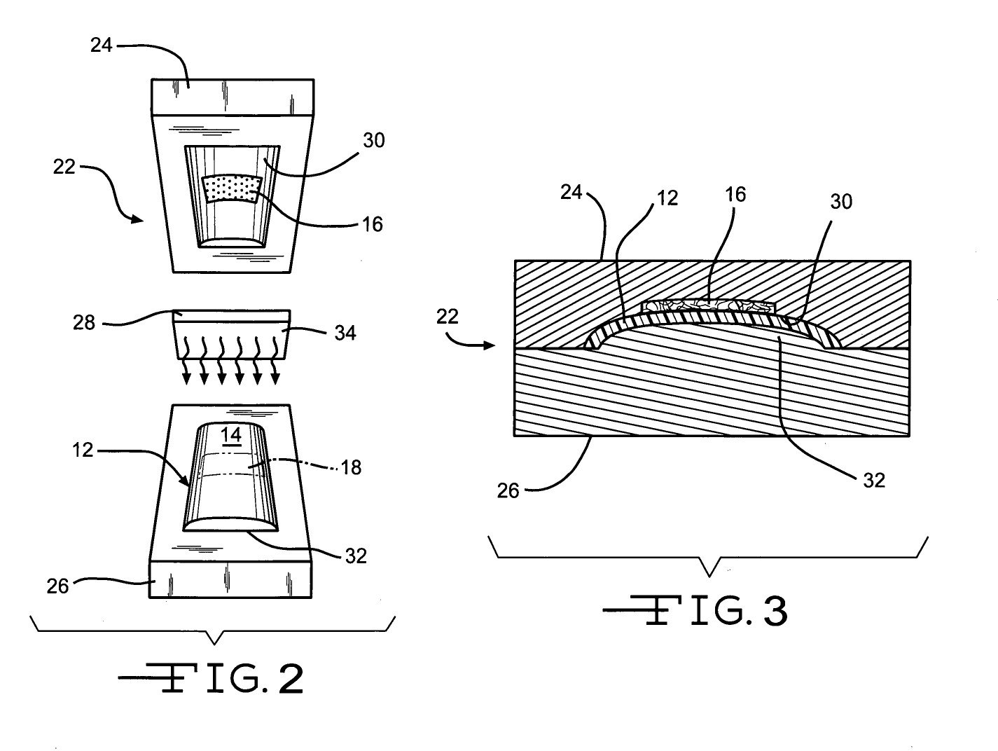

A first embodiment of the method of the invention is illustrated in FIGS. 2 and 3. Referring to FIG. 2, there is illustrated a press, indicated generally at 22, which is adapted to be used in accordance with the method of this invention. Typically, the press 22 includes a first press half 24, a second press half 26, and a source of heat 28. The first press half 24 includes a first nest 30, and the second press half 26 includes a second nest 32. Although illustrated schematically in FIGS. 2 through 7, it will be appreciated that the press halves 24 and 26, and the nests 30 and 32 may be of any desired shape and contour. It will be appreciated that as used herein, the term nest is defined as having any desired shape, including any of a substantially convex, substantially concave, or a combination convex and concave shape.

The first press half 24 and second press half 26 are preferably mounted to platens (not shown) of a press assembly (not shown) with sufficient tonnage to accomplish the method herein described. The press 22 can be moved between an open position, as shown in FIG. 2 and a closed position, as shown in FIG. 3. The source of heat 28 has a heat generating surface 34 and is disposed between the first press half 24 and the second press half 26.

It will be appreciated, that in accordance with each embodiment of the invention, as will be described below, a first step of the method of the invention includes providing a suitable press, such as the press 22.

A second step of the method of this invention is illustrated generally in FIG. 2. In the second step, the press 22 is moved to the open position. It will be appreciated that the open position can be achieved by moving the first press half 24 away relative to the second press half 26, moving the second press half 26 away relative to the first press half 24, or moving each of the first press half 24 and the second press half 26 away from the other.

A substrate, such as the trim panel 12 is then disposed in the first nest 30. A first material, such as the coverstock 16 is disposed in the second nest 32. The coverstock 16 can be held against the surface of the second nest 32 by any desired means, such as for example, by vacuum or by needle pad retention. It will be appreciated that if desired, the coverstock 16 can be disposed in the first nest 30, and the trim panel 12 can be disposed in the second nest 32. In the exemplary embodiment illustrated, the coverstock 16 is shown smaller than the trim panel 12 to which it is attached (i.e. equal in size to the accent region 18). It will be appreciated however, that the coverstock 16 can be any desired size. For example, the coverstock 16 can be equal in size to the A-side surface 14 of the trim panel 12 to which it is attached. The source of heat 28 is then positioned between the first press half 24 and the second press half 26, such that the heat generating surface 34 is facing the trim panel 12.

The source of heat 28 is preferably a source of radiant heat. The source of heat 28 can be any suitable source of radiant heat sufficient to melt the surface of a thermoplastic substrate as described herein. The source of radiant heat can be provided by any desired means. For example, the radiant heat can provided by a flash of high intensity heat from a light source, such as shown generally at 36 in FIG. 5, by infrared light, by a laser, or by any other desired source of radiant heat. Additionally, other sources of heat can be used, such as for example, natural gas or LP fired heat, quartz, contact, and hot air heat systems. Preferably, the source of heat 28 is fixed relative to the surface of the trim panel 12, such that the portion of the A-side surface of the trim panel 12 to be melted, such as the accent region 18, is exposed to heat from the source of heat 28 substantially simultaneously. As used herein, a flash is defined as a short burst of heat having a duration within the range of from about 0.2 seconds to about 0.8 seconds. High intensity is defined as having a temperature sufficient to melt the substrate 12. For example, for a substrate made of polypropylene, high intensity heat is defined as within the range of from about 400 degrees F. to about 480 degrees F.

A portion of the surface of the trim panel 12, such as the accent area 18, is then exposed to heat from the source of heat 28 such that the surface of the trim panel 12 within the accent area 18 is melted. It will be appreciated that any desired combination of the duration and intensity of the heat can be used such that within the range of from about 0.001 inches to about 0.010 inches of the A-side surface of the trim panel 12 is melted. It will be further appreciated the as used herein, the term melted is defined as softened such that the B-side surface of the coverstock 16 becomes embedded in the softened A-side surface of the trim panel 12. Further, when cooled, the coverstock then becomes mechanically bonded or fused to the trim panel 12.

In a third step of the method, the source of heat 28 is moved from between the press halves 24 and 26. In a fourth step of the method, the press halves 24 and 26 are moved to the closed position, as shown in FIG. 3. In the closed position, the coverstock 16 is positioned onto the trim panel 12 so as to bring the coverstock 16 into contact with the melted surface of the trim panel 12. The coverstock 16 thereby becomes bonded to the trim panel 12 to form the vehicle trim panel assembly 10. It will be appreciated that the closed position can be achieved by moving the first press half 24 toward the second press half 26, moving the second press half 26 toward the first press half 24, or moving each of the first press half 24 and the second press half 26 toward the other.

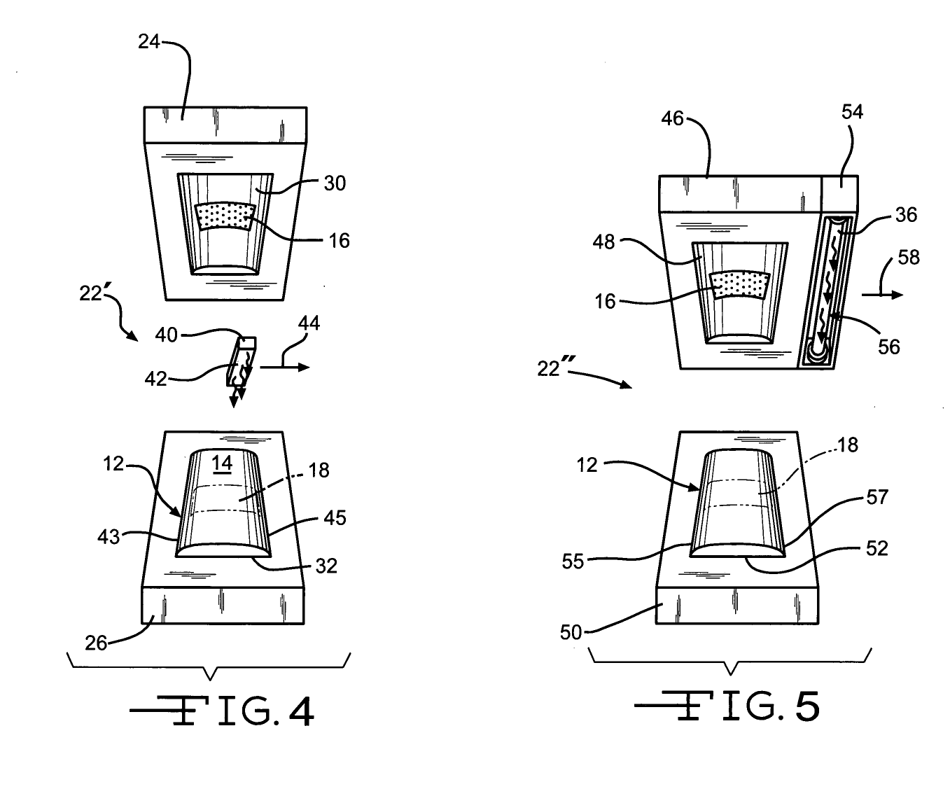

Referring now to FIG. 4, and using like reference numbers to indicate corresponding parts, there is illustrated a second embodiment of the method according to the present invention.

In the second embodiment, a press, indicated generally at 22′, is provided. The press 22′ includes the first press half 24, the second press half 26, and a source of heat 40. The source of heat 40 has a heat generating surface 42 and is disposed between the first press half 24 and the second press half 26. The source of heat 40 is preferably a source of radiant heat. The source of heat 40 can be any suitable source of radiant heat sufficient to melt the surface of trim panel 12 as described herein. The source of radiant heat can be provided by any desired means. For example, the radiant heat can provided by a flash of high intensity heat from a light source, by infrared light, by a laser, or by any other desired source of radiant heat. Additionally, other sources of heat can be used, such as for example, natural gas or LP fired heat, quartz, contact, and hot air heat systems. The source of heat 40 is preferably movable relative to the surface of the trim panel 12.

According to the second embodiment of the method of the invention, the press 22′ is moved to the open position. The trim panel 12 is then disposed in the first nest 30, and the coverstock 16 is disposed in the second nest 32. The source of heat 40 is positioned between the first press half 24 and the second press half 26, such that the heat generating surface 42 is facing the trim panel 12. A source of power (not shown) then causes the source of heat 40 to move from a first side 43 of the trim panel 12 to a second side 45 of the trim panel 12, as shown by an arrow 44. The portion of the A-side surface of the trim panel 12 to be melted, such as the accent region 18, is thereby exposed to heat from the source of heat 40, as the source of heat 40 moves in the direction of the arrow 44.

The press halves 24 and 26 are then moved to the closed position, as shown in FIG. 3. In the closed position, the coverstock 16 is positioned onto the trim panel 12 so as to bring the coverstock 16 into contact with the melted surface of the trim panel 12. The coverstock 16 thereby becomes bonded to the trim panel 12 to form the vehicle trim panel assembly 10.

In the second embodiment of the method, the heat source y has been described as moving relative to the trim panel 12 and the first nest 30. It will be appreciated however, that in the first nest 30 may be moved relative to the source of heat 40, or that both the source of heat 40 and the first nest 30 may be moved relative to each other.

Referring now to FIG. 5, and using like reference numbers to indicate corresponding parts, there is illustrated a third embodiment of the method according to the present invention. In the third embodiment, a press, indicated generally at 22″, is provided. The press 22″ includes a first press half 46 having a first nest 48, a second press half 50 having a second nest 52, and the source of heat 54.

The source of heat 54 has a heat generating element of surface 56 and is disposed adjacent the second nest 52 of the second press half 50. Preferably, the source of heat 54 is mounted to the second press half 50, as shown in FIG. 5.

The source of heat 54 is preferably a source of radiant heat. The source of heat 54 can be any suitable source of radiant heat sufficient to melt the surface of trim panel 12 as described herein. The source of radiant heat can be provided by any desired means. For example, the radiant heat can provided by a flash of high intensity heat from a light source, by infrared light, by a laser, or by any other desired source of radiant heat. Additionally, other sources of heat can be used, such as for example, natural gas or LP fired heat, quartz, contact, and hot air heat systems.

According to the third embodiment of the method of the invention, the press 22″ is moved to the open position. The trim panel 12 is then disposed in the first nest 48, and the coverstock 16 is disposed in the second nest 52. The source of heat 54 is positioned such that the heat generating surface 56 is facing the trim panel 12. Preferably, the second press half 50 is movable relative to the surface of the trim panel 12. A source of power (not shown) causes the second press half 50, and the source of heat 54 mounted thereto, to move from a first side 55 of the trim panel 12 to a second side 57 of the trim panel 12, as shown by an arrow 58. The portion of the A-side surface of the trim panel 12 to be melted, such as the accent region 18, is thereby exposed to heat from the source of heat 54, as the second press half 50 and the source of heat 54 move in the direction of the arrow 58.

The press halves 46 and 50 are then moved to the closed position (not shown). In the closed position, the coverstock 16 is positioned onto the trim panel 12 so as to bring the coverstock 16 into contact with the melted surface of the trim panel 12, as shown in FIG. 3. The coverstock 16 thereby becomes bonded to the trim panel 12 to form the vehicle trim panel assembly 10.

In the third embodiment of the method, the source of heat 54 has been described as being moving relative to the trim panel 12 and the first press half 46. It will be appreciated however, that in the first press half 46 may be moved relative to the second press half 50, or that both the first press half 46 and second press half 50 may be moved relative to each other. It will be further appreciated that the source of heat 54 need not be mounted to the second press half 50, as shown in FIG. 5. For example, if desired, the source of heat 54 can be disposed adjacent the second press half 50 such that the source of heat 54 and the second press half 50 move simultaneously.

In each of the first, second, and third embodiments of the method of the invention, thermoplastic material of the A-side surface 14 of the trim panel 12 is heated by a source of heat 28, 40, or 54. It will be appreciated however, that a coverstock 60 can include a B-side layer, as shown at 62 in FIG. 7, and a coverstock layer 64. The B-side layer 62 is formed of any desired thermoplastic, such as polypropylene. As appreciated by those skilled in the art, the B-side layer 62 may be fabricated of other materials, such as, polyurethane, solid molded vinyl, or any other desired thermoplastic material. The coverstock layer 64 is formed of any desired material, such as, for example, from vinyl, cloth, carpet, leather, and the like.

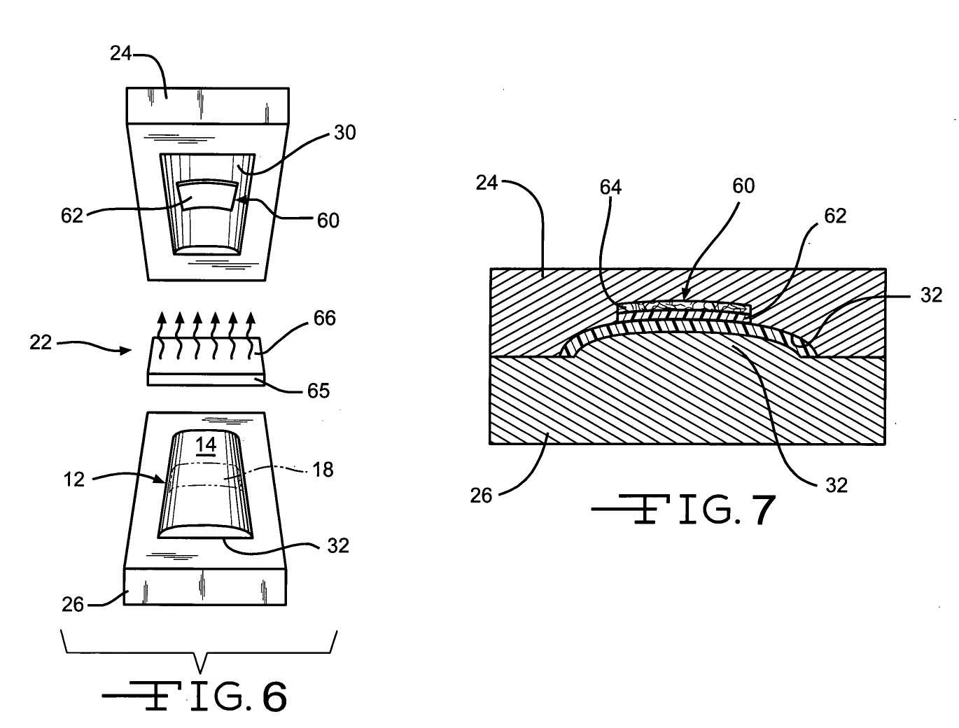

When such a coverstock 60 is provided, the heat source, such as a source of heat 65 shown in FIG. 6, is disposed between the first press half 24 and the second press half 26 such that a heat generating surface 66 is facing the B-side layer 62 of the coverstock 60. The B-side layer 62 of the coverstock 60 is then exposed to heat from the source of heat 66 and caused to melt, as described herein.

As previously disclosed, the press halves 24 and 26 are then moved to the closed position, as shown in FIG. 7. In the closed position, the coverstock 16 is positioned onto the trim panel 12 so as to bring the melted B-side surface 66 of the coverstock 60 into contact with the trim panel 12. The coverstock 60 thereby becomes bonded to the trim panel 12 to form the vehicle trim panel assembly 10.

One advantage of the method of the invention is that no adhesive is required between the trim panel 12 and the coverstock 16 and 60, thereby reducing cost and eliminating the time required for the adhesive to cure. Volatile Organic Compounds (VOC) which can be associated with adhesives are also eliminated. Because no adhesive is used, humidity in the manufacturing facility need not be controlled.

In the exemplary embodiment of the method wherein the coverstock includes a B-side layer of thermoplastic, such as polypropylene, the coverstock has increased rigidity. Such increased rigidity provides a coverstock that can more easily retain its shape prior to being placed in the press nest. The thermoplastic layer further provides an air-impermeable layer, allowing the use of a vacuum to retain the coverstock in the press nest, regardless of the nest orientation.

An advantage of using a flash of high intensity heat to melt the surface of either the trim panel or the thermoplastic layer of the coverstock is that the process is very fast. Such a fast process provides for an increase in the number of parts minute produced.

Another advantage of the method of the invention is that bond produced by the melting or fusing of the coverstock to the trim panel is more robust than an adhesive bond.

The principle and mode of operation of this invention have been described in its preferred embodiments. However, it should be noted that this invention may be practiced otherwise than as specifically illustrated and described without departing from its scope.

1. A method of manufacturing a vehicle trim component, the method comprising the steps of:
a. providing a thermoplastic substrate;
b. providing a first material, wherein the first material is different from the material of the thermoplastic substrate;
c. exposing a portion of a surface of the thermoplastic substrate to a source of heat such that the portion of the surface of the thermoplastic substrate exposed to the source of heat is melted; and
d. positioning the first material onto the thermoplastic substrate so as to bring the first material into contact with the melted surface of the thermoplastic substrate, thereby bonding the first material to the thermoplastic substrate and forming a vehicle trim component.

2. The method according to claim 1, wherein step (c) includes melting within the range of from about 0.001 inches to about 0.010 inches of the surface of the thermoplastic substrate.

3. The method according to claim 1, wherein the source of heat includes a source of radiant heat.

4. The method according to claim 3, wherein the radiant heat is provided by a flash of high intensity heat from a light source.

5. The method according to claim 3, wherein the radiant heat is provided by infrared light.

6. The method according to claim 3, wherein the radiant heat is provided by a laser.

7. The method according to claim 1, wherein the source of heat is fixed relative to the surface of the thermoplastic substrate.

8. The method according to claim 1, wherein the source of heat is movable relative to the surface of the thermoplastic substrate.

9. The method according to claim 1, wherein the first material further comprises a thermoplastic layer.

10. The method according to claim 9, further including exposing a surface of the thermoplastic layer of the first material to a source of heat such that the surface of the thermoplastic layer exposed to the source of heat is melted.

11. The method according to claim 1, wherein the method further includes the steps of:
prior to step (c), providing a press assembly having a first press half defining a first nest and a second press half defining a second nest, the press assembly being movable between an open position to expose the first and the second nests, and a closed position, wherein thermoplastic substrate is disposed into one of the first nest and the second nest;
disposing the first material into the other one of the first nest and the second nest; and
subsequent to step (c), moving the press assembly to the closed position so as to bring the first material into contact with the melted surface of the thermoplastic substrate.

12. The method according to claim 11, further including the steps of:
providing a source of heat adjacent to the other one of the first nest and the second nest in which the first material is disposed; and
moving the source of heat relative to the thermoplastic substrate to expose a portion of the surface of the thermoplastic substrate to the source of heat such that the portion of the surface of the thermoplastic substrate exposed to the source of heat is melted.

13. A method of manufacturing a vehicle trim component, the method comprising the steps of:
a. providing a substrate;
b. providing a first material comprising a first layer and a thermoplastic layer;
c. exposing portion of a surface of the thermoplastic layer of the first material to a source of heat such that the portion of the surface of the thermoplastic layer exposed to the source of heat is melted; and
d. positioning the first material onto the substrate so as to bring the melted surface of the thermoplastic layer into contact with the substrate, thereby bonding the first material to the substrate and forming a vehicle trim component.

14. The method according to claim 13, wherein the substrate is formed of thermoplastic.

15. The method according to claim 14, wherein the first layer of the first material is different from the material of the thermoplastic substrate.

16. The method according to claim 13, wherein the source of heat includes a source of radiant heat.

17. The method according to claim 13, wherein the source of heat is fixed relative to the surface of the thermoplastic layer of the first material.

18. The method according to claim 13, wherein the source of heat is movable relative to the surface of the thermoplastic layer of the first material.

19. The method according to claim 13, wherein step (c) includes melting within the range of from about 0.001 inches to about 0.010 inches of the surface of the thermoplastic layer.

20. A method of manufacturing a vehicle trim component, the method comprising the steps of:
a. providing a press assembly having a first press half defining a first nest and a second press half defining a second nest, the press assembly being movable between an open position to expose the first and the second nests, and a closed position;
b. disposing a thermoplastic substrate into the first nest;
c. disposing a first material into the second nest, wherein the first material is different from the material of the thermoplastic substrate;
d. providing a source of high intensity heat;
e. moving the source of heat relative to the thermoplastic substrate to expose a surface of the thermoplastic substrate to the source of heat such that within the range of from about 0.001 inches to about 0.010 inches of the surface of the thermoplastic substrate exposed to the source of heat is melted; and
f. moving the press assembly to the closed position so as to bring the melted surface of the thermoplastic substrate into contact with the first material, thereby bonding the first material to the thermoplastic substrate and forming a vehicle trim component.
